(19) United States
(12) Patent Application Publication
(10) Pub. No.: US 2021/0142711 A1
(43) Pub. Date: May 13, 2021

(54) ARTIFICIAL INTELLIGENCE APPARATUS AND METHOD FOR CALIBRATING DISPLAY PANEL IN CONSIDERATION OF USER'S PREFERENCE

(71) Applicant: LG ELECTRONICS INC., Seoul (KR)

(72) Inventors: Jichan MAENG, Seoul (KR); Jonghoon CHAE, Seoul (KR)

(73) Assignee: LG ELECTRONICS INC., Seoul (KR)

(21) Appl. No.: 16/737,406

(22) Filed: Jan. 8, 2020

(30) Foreign Application Priority Data
Nov. 12, 2019 (KR) 10-2019-0144460

(51) Int. Cl. G09G 3/20; G06N 3/08

(52) U.S. Cl. CPC G09G 3/2003; G09G 2320/08; G09G 2320/0693; G06N 3/08

(57) ABSTRACT

An artificial intelligence (AI) apparatus for calibrating a display panel includes a camera and a processor. The processor is configured to receive a captured image of the display panel captured via the camera, receive a reference image corresponding to the captured image, receive context information at a reception time of the captured image, determine an image preprocessing parameter set based on the captured image, the reference image, and the context information, preprocess the reference image based on the image preprocessing parameter, and calibrate the display panel based on the preprocessed reference image and the captured image.

### CROSS-REFERENCE TO RELATED APPLICATIONS

This application claims priority benefit to Korean Patent Application No. 10-2019-0144460 filed in the Republic of Korea on Nov. 12, 2019, the entire contents of which are hereby incorporated by reference in its entirety.

### BACKGROUND

The present disclosure relates to an artificial intelligence apparatus and a method for calibrating a display panel in consideration of a user's preference.

Recently, display devices are implemented not only as TVs or monitors, but also as various devices such as a digital signage or an outdoor signboard, and the range of use for the display devices has been extensively increased. In particular, situations in which one large display is formed by connecting a plurality of display panels have increased.

However, when a plurality of display panels are used to constitute a single large display, distortion may occur in an output image due to the mismatch of a color or a position between the display panels. In addition, even in a display composed of a single display panel, the distortion may occur in the output image due to the mismatch of the color between output elements. Further, a flexible display may cause the distortion in an image observed by a user due to the bending of the display even if there is no distortion in an image which is actually output. Therefore, it is necessary to provide a technique for calibrating/correcting a display panel such that the distortion does not occur in an image actually observed by a user.

However, a user or an administrator of a display panel may change the setting of the display panel according to a type of an image to be output or a context of the weather or surrounding environment. Therefore, there is a need to adjust or correct a display panel in consideration of a user's preference.

### SUMMARY

The present disclosure provides an artificial intelligence apparatus and a method for calibrating a color of a display panel so that an image output from a display panel observed by a user has a user's preferred color and no color distortion occurs.

One embodiment of the present disclosure provides an AI apparatus and a method for calibrating a display panel, which determines an image preprocessing parameter set based on a captured image of the display panel, a reference image for the captured image, and context information at a reception time of the captured image, preprocess the reference image by using the image preprocessing parameter set, and calibrates the display panel based on the preprocessed reference image and the captured image.

In addition, one embodiment of the present disclosure provides an AI apparatus and a method for determining image preprocessing parameters in consideration of a user's image preprocessing record.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating an AI apparatus according to an embodiment of the present disclosure.

FIG. 2 is a block diagram illustrating an AI server according to an embodiment of the present disclosure.

FIG. 3 is a view illustrating an AI system according to an embodiment of the present disclosure.

FIG. 4 is a block diagram illustrating an AI apparatus according to an embodiment of the present disclosure.

FIG. 5 is a view illustrating an AI system according to an embodiment of the present disclosure.

FIG. 6 is a flowchart illustrating a method for calibrating a display panel according to an embodiment of the present disclosure.

FIG. 7 is a view illustrating a method for calibrating a display panel according to an embodiment of the present disclosure.

FIG. 8 is a view illustrating a method for determining an image preprocessing parameter set according to an embodiment of the present disclosure.

FIG. 9 is a view illustrating an example of training data for an image preprocessing parameter determination model according to an embodiment of the present disclosure.

FIG. 10 is a flowchart illustrating an example of step S611 of calibrating a display panel illustrated in FIG. 6 according to an embodiment of the present disclosure.

FIG. 11 is a view illustrating a method for removing color distortion of a display panel according to an embodiment of the present disclosure.

FIG. 12 is a view illustrating a method for determining a region where color distortion occurs according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for training data is given, and the label may mean the correct answer (or result value) that the artificial neural network infers when the training data is input to the artificial neural network. The unsupervised learning may refer to a method of learning an artificial neural network in a state in which a label for training data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

Here, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

FIG. 1 is a block diagram illustrating an AI apparatus 100 according to an embodiment of the present disclosure.

Hereinafter, the AI apparatus 100 may be referred to as a terminal.

The AI apparatus (or an AI device) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI apparatus 100 may include a communication unit 110, an input unit 120, a learning processor 130, a sensing unit 140, an output unit 150, a memory 170, and a processor 180.

The communication unit 110 may transmit and receive data to and from external devices such as other 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™RFID (Radio Frequency Identification), Infrared Data Association (IrDA), ZigBee, NFC (Near Field Communication), and the like.

The input unit 120 may acquire various kinds of data.

Here, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a training data for model learning and an input data to be used when an output is acquired by using learning model. The input unit 120 may acquire raw input data. Here, the processor 180 or the learning processor 130 may extract an input feature by preprocessing the input data.

The learning processor 130 may learn a model composed of an artificial neural network by using training data. The learned artificial neural network may be referred to as a learning model. The learning model may be used to an infer result value for new input data rather than training data, and the inferred value may be used as a basis for determination to perform a certain operation.

Here, the learning processor 130 may perform AI processing together with the learning processor 240 of the AI server 200.

Here, the learning processor 130 may include a memory integrated or implemented in the AI apparatus 100. Alternatively, the learning processor 130 may be implemented by using the memory 170, an external memory directly connected to the AI apparatus 100, or a memory held in an external device.

The sensing unit 140 may acquire at least one of internal information about the AI apparatus 100, ambient environment information about the AI apparatus 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

Here, the output unit 150 may include a display for outputting time information, a speaker for outputting auditory information, and a haptic module for outputting haptic information.

The memory 170 may store data that supports various functions of the AI apparatus 100. For example, the memory 170 may store input data acquired by the input unit 120, training data, a learning model, a learning history, and the like.

The processor 180 may determine at least one executable operation of the AI apparatus 100 based on information determined or generated by using a data analysis algorithm or a machine learning algorithm. The processor 180 may control the components of the AI apparatus 100 to execute the determined operation.

To this end, the processor 180 may request, search, receive, or utilize data of the learning processor 130 or the memory 170. The processor 180 may control the components of the AI apparatus 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI apparatus 100 to drive an application program stored in memory 170. Furthermore, the processor 180 may operate two or more of the components included in the AI apparatus 100 in combination to drive the application program.

FIG. 2 is a block diagram illustrating an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. Here, the AI server 200 may be included as a partial configuration of the AI apparatus 100, and may perform at least part of the AI processing together.

The AI server 200 may include a communication unit 210, a memory 230, a learning processor 240, a processor 260, and the like.

The communication unit 210 can transmit and receive data to and from an external device such as the AI apparatus 100.

The memory 230 may include a model storage unit 231. The model storage unit 231 may store a learning or learned model (or an artificial neural network 231a) through the learning processor 240.

The learning processor 240 may learn the artificial neural network 231a by using the training data. The learning model may be used in a state of being mounted on the AI server 200 of the artificial neural network, or may be used in a state of being mounted on an external device such as the AI apparatus 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

FIG. 3 is a view illustrating an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI apparatuses 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI apparatuses constituting the AI system 1, that is, the robot 100a, the self-driving vehicle 100b, the XR device 100c, the smartphone 100d, or the home appliance 100e through the cloud network 10, and may assist at least part of AI processing of the connected AI apparatuses 100a to 100e.

Here, the AI server 200 may learn the artificial neural network according to the machine learning algorithm instead of the AI apparatuses 100a to 100e, and may directly store the learning model or transmit the learning model to the AI apparatuses 100a to 100e.

Here, the AI server 200 may receive input data from the AI apparatuses 100a to 100e, may infer the result value for the received input data by using the learning model, may generate a response or a control command based on the inferred result value, and may transmit the response or the control command to the AI apparatuses 100a to 100e.

Alternatively, the AI apparatuses 100a to 100e may infer the result value for the input data by directly using the learning model, and may generate the response or the control command based on the inference result.

Hereinafter, various embodiments of the AI apparatuses 100a to 100e to which the above-described technology is applied will be described. The AI apparatuses 100a to 100e illustrated in FIG. 3 may be regarded as a specific embodiment of the AI apparatus 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

Here, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. Here, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling route by using the recognized surrounding information or object information. The learning model may be learned directly from the self-driving vehicle 100a or may be learned from an external device such as the AI server 200.

Here, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external device to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. Here, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HIVID), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

Here, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given route without the user's control or moves for itself by determining the route by itself

The robot 100a and the self-driving vehicle 100b having the self-driving function may use a common sensing method to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

Here, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this situation, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

Here, when the XR object is output to the HUD, at least part of the XR object may be output to overlap the actual object to which the passenger's gaze is directed. Meanwhile, when the XR object is output to the display provided in the self-driving vehicle 100b, at least part of the XR object may be output to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIG. 4 is a block diagram illustrating an AI apparatus 100 according to an embodiment of the present disclosure.

The redundant repeat of FIG. 1 will be omitted below.

The communication unit 110 may also be referred to as a communication modem or a communication circuit.

Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information input from a user and the AI apparatus 100 may include at least one camera 121 in order for inputting image information.

The camera 121 processes image frames such as a still image or a video obtained by an image sensor in a video call mode or a capturing mode. The processed image frame may be displayed on the display 151 or stored in the memory 170.

The microphone 122 processes external sound signals as electrical voice data. The processed voice data may be utilized variously according to a function (or an application program being executed) being performed in the AI apparatus 100. Moreover, various noise canceling algorithms for removing noise occurring during the reception of external sound signals may be implemented in the microphone 122.

The user input unit 123 is to receive information from a user and when information is input through the user input unit 123, the processor 180 may control an operation of the AI apparatus 100 to correspond to the input information.

The user input unit 123 may include a mechanical input means (or a mechanical key, for example, a button, a dome switch, a jog wheel, and a jog switch at the front, back or side of the AI apparatus 100) and a touch type input means. As one example, a touch type input means may include a virtual key, a soft key, or a visual key, which is displayed on a touch screen through software processing or may include a touch key disposed at a portion other than the touch screen.

The sensing unit 140 may also be referred to as a sensor unit.

The output unit 150 may include at least one of a display 151, a sound output module 152, a haptic module 153, or an optical output module 154.

The display 151 may display (output) information processed in the AI apparatus 100. For example, the display 151 may display execution screen information of an application program running on the AI apparatus 100 or user interface (UI) and graphic user interface (GUI) information according to such execution screen information.

The display 151 may be formed with a mutual layer structure with a touch sensor or formed integrally, so that a touch screen may be implemented. Such a touch screen may serve as the user input unit 123 providing an input interface between the AI apparatus 100 and a user, and an output interface between the AI apparatus 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the AI apparatus 100. An example of an event occurring in the AI apparatus 100 includes message reception, call signal reception, missed calls, alarm, schedule notification, e-mail reception, and information reception through an application.

FIG. 5 is a view illustrating an AI system 1 according to an embodiment of the present disclosure.

Referring to FIG. 5, an AI system 1 according to one embodiment may include an AI apparatus 100, an AI server 200, and a display device 300. At least one of the AI apparatus 100, the AI server 200, or the display device 300 may communicate with each other using a wired or wireless communication technology. The devices 100, 200, and 300 may communicate with each other through a base station, a router, or the like, but may directly communicate with each other using a short-range communication technology. For example, the devices 100, 200, 300 may communicate with each other directly or through a base station using 5G (5th generation) communication.

The AI apparatus 100 may determine whether distortion occurs with respect to the display panel of the display device 300, determine setting values for calibrating the distortion, and transmit the determined setting values to the display device 300 in order to correct the distortion of the display panel of the display device 300. The distortion of the display panel may include color distortion or position distortion of the display panel.

The color distortion of the display panel may refer to a color distortion between display panels when a plurality of display panels are connected to form one display panel, but may occur between display elements within one display panel. In particular, in a flexible display panel, even if there is no color distortion in each display element, an observer may be observed that there is a color distortion due to the bending of the display panel, which is also referred to as the color distortion. The color distortion of the display panel may include color temperature distortion or luminance distortion.

Similarly, when a plurality of display panels are connected to form one display panel group, the position distortion of the display panel may refer to the distortion of arrangement or alignment between the display panels. Hereinafter, the display panel includes a display panel group unless otherwise specified.

The AI apparatus 100 may determine the color distortion or the position distortion existing on the display panel by using the captured image of the display panel of the display device 300, determine a calibration value for correcting the distortion, and transmit the calibration value to the display device 300. In addition, the AI apparatus 100 may again recalibrate the display panel by using the captured image of the display panel of the display device 300. The AI apparatus 100 may be a fixed device, but may be a robot that can move, such as a robot cleaner or a guide robot.

The AI server 200 may receive data to be used to calibrate the display panel of the display device 300 from the AI apparatus 100, and determine setting values for calibrating the display panel based on the received data.

The display device 300 may include a display panel, a processor (or a display controller) and a communication unit, and output an image through the display panel. The display device 300 may include a rollable display, a flexible display, a micro LED display, an LCD, and the like.

In FIG. 5, the AI apparatus 100 and the display device 300 are illustrated as being separated from each other, but the present disclosure is not limited thereto. That is, according to another embodiment, the AI apparatus 100 may refer to a display device having an AI function, and the AI apparatus 100 and the display device 300 illustrated in FIG. 5 may be configured as one. In this situation, a processor 180 of the AI apparatus 100 may control its display panel or a display 151.

FIG. 6 is a flowchart illustrating a method for calibrating a display panel according to an embodiment of the present disclosure.

Referring to FIG. 6, the processor 180 of the AI apparatus 100 receives a captured image for a display panel via the camera 121 (S601).

The display panel may refer to the display 151 included in the AI apparatus 100 or may refer to a display panel of the external display device 300. The display panel includes various panels, such as an LCD panel, an LED panel, or an OLED panel. The captured image of the display panel refers to an image obtaining by capturing the display panel and may be referred to as captured image data.

The camera 121 may be an RGB camera, and the captured image may be an RGB image. The camera 121 may be installed at a fixed position facing the display panel to be subjected to color calibration and have a fixed viewpoint. However, the camera 121 may be installed in the body of the AI apparatus, and the viewpoint may be changed as the AI apparatus 100 moves.

The camera 121 may receive a captured image by using a predetermined camera setting value. The camera setting value may include a shutter speed, a diaphragm, an ISO, a white balance, and the like.

The processor 180 may remove a region other than a display panel region from the received captured image and convert the display panel region into a rectangular shape. If the viewpoint of the camera 121 looks at the center from the height of the center of the display panel, the display panel included in the captured image may have a rectangular shape. However, if the viewpoint of the camera 121 does not look at the display panel from the front center, the display panel included in the captured image may not have a rectangular shape like a rhombus. If the region of the display panel is not rectangular in the captured image, the processor 180 may convert the captured image so that the region of the display panel becomes rectangular.

The processor 180 of the AI apparatus 100 receives a reference image corresponding to the captured image (S603).

The reference image may refer to a content image to be output via the display panel and may be referred to as reference image data. That is, if the display panel displays the reference image, the captured image may be generated by capturing the image displayed on the display panel. The reference image corresponding to the captured image may refer to a content image to be output on the display panel at the same timestamp.

The reference image may refer to a content image output or displayed on the display panel and may be referred to as a content image or content image data. Therefore, the reference image refers to an image, such as a photo or a video, not an image for calibrating the color of the display panel.

The processor 180 of the AI apparatus 100 receives context information at a reception time of the captured image (S605).

The context information may include weather information, time information including date and time, and the like. The weather information may include at least one of first weather information indicating a water phenomenon in the atmosphere such as rain, snow, hail, and fog, second weather information indicating a dust phenomenon in the atmosphere such as yellow dust, fog, and smoke, third weather information indicating light phenomenon in the atmosphere such as rainbow, haze, and glow, or fourth weather information indicating an electric phenomenon in the atmosphere such as lightning and aurora. In addition, the weather information may include weather condition, temperature, humidity, and air quality. The air quality may include pm2.5, pm10, and the like as fine dust levels.

The processor 180 may receive weather information from the AI server 200 or another external server via the communication unit 110. The processor 180 may receive time information from the AI server 200 or another external server via the communication unit 110, and may receive time information from a clock embedded in the processor 180.

The processor 180 of the AI apparatus 100 determines an image preprocessing parameter set based on the captured image, the reference image, and the context information (S607).

The image preprocessing parameter set is a collection of parameters used to preprocess the reference image and may include a brightness calibration parameter, a saturation calibration parameter, a color calibration parameter, a noise cancellation parameter, and the like. The term “preprocessing” may mean that processing is performed on the reference image before calibrating the display panel.

The processor 180 may determine the image preprocessing parameter set in consideration of a user's (or administrator's) image preprocessing record. The user may preprocess the image differently according to the output image and the context when outputting the image or characteristics of the reference image. Therefore, the user's preprocessing record may include content image, the captured image, the context information, and the image preprocessing parameters.

The image preprocessing record may include an image filter application record. The image filter may refer to an image preprocessing parameter set preset. Since the image filter application record indicates a record of which the image filter is applied among a plurality of predetermined image filters, and each image filter may be represented by image preprocessing parameters, the image filter application record may be represented by image preprocessing parameter sets. For example, if there is an image preprocessing record that a user applies a sepia tone filter on a particular image in a particular situation, the processor 180 may determine the image preprocessing parameter set as the image preprocessing parameter set corresponding to the sepia tone filter for the particular situation and the particular image.

The processor 180 may extract a feature from each of the captured image and the reference image, and determine an image preprocessing parameter set in consideration of each extracted feature and context information. The feature may include distribution information such as color, brightness, and saturation. For example, the processor 180 may differently determine an image preprocessing parameter set for a high saturation image and an image preprocessing parameter set for a low saturation image.

In one embodiment, if there is an image preprocessing record in a situation corresponding to the received captured image, the received reference image, and the received context information, the processor 180 may determine image preprocessing parameters by using the corresponding image preprocessing record. For example, if there is an image preprocessing record in the same situation as the current situation among the user's image preprocessing records, the processor 180 may determine an image preprocessing parameter set that performs the same image preprocessing as the preprocessing record thereof.

In one embodiment, the processor 180 may determine the image preprocessing parameter from the received captured image, the received reference image, and the received context information by using a preprocessing parameter determination model learned by using the image preprocessing record. The preprocessing parameter determination model may include an artificial neural network and may be learned by using a machine learning algorithm or a deep learning algorithm.

The processor 180 of the AI apparatus 100 preprocesses the reference image by using the image preprocessing parameter set (S609).

The processor 180 may preprocess the reference image based on each image preprocessing parameter included in the determined image preprocessing parameter set. The preprocessing of the reference image may include processing of changing an attribute of the reference image or modifying or transforming the image based on the determined image preprocessing parameters. For example, the processor 180 may calibrate brightness based on a determined brightness calibration parameter with respect to the reference image, calibrate saturation based on a determined saturation calibration parameter, calibrate color based on a determined color calibration parameter, and remove noise based on a determined noise removal parameter.

Since the image preprocessing parameter set is determined in consideration of the user's image preprocessing record, the determined image preprocessing parameter set may include image preprocessing parameters to which a user's image preprocessing preference is reflected.

The processor 180 of the AI apparatus 100 calibrates the display panel based on the preprocessed reference image and the captured image (S611).

The processor 180 may calibrate the display panel for each predetermined unit. The predetermined unit may include a unit pixel constituting the display panel, a pixel group having a predetermined size, and the like. If a plurality of display panels constitute one display panel group, the display panel may refer to a display panel group. In this situation, the predetermined unit for the display panel (display panel group) may include a unit display panel constituting the display panel group. That is, color distortion of the display panel may occur between unit pixels constituting a single display panel and may also occur between unit display panels constituting a single display panel group.

The processor 180 may compare the preprocessed reference image with the captured image, calculate an offset for an attribute value, such as color, brightness, and saturation for each predetermined unit, determine a display panel calibration value based on the calculated offset, and calibrate the display panel based on the determined display panel calibration value. Alternatively, the processor 180 may compare the preprocessed reference image with the captured image, calculate an offset for an attribute value such as brightness, gamma, contrast, and balance for each predetermined unit, determine a display panel calibration value based on the calculated offset, and calibrate the display panel based on the determined display panel calibration value.

FIG. 6 illustrates only one cycle of a method for calibrating the display panel in consideration of a user's preference according to an embodiment. Steps shown in FIG. 6 may be performed repeatedly. Accordingly, the AI apparatus 100 may process the reference image by repeatedly reflecting the user's preference and may calibrate the display panel by using the preprocessed reference image. Since the AI apparatus 100 calibrates the display panel by reflecting the user's preference in real time or periodically, the output of the display panel according to the user's preference may be maintained even when the context information changes as the weather changes, the reference image changes, or the captured image changes as the state of the display panel changes.

The order of the operations illustrated in FIG. 6 is merely an example, and the present disclosure is not limited thereto. That is, in one embodiment, the order of some of steps illustrated in FIG. 6 may be mixed. In addition, in one embodiment, some of steps illustrated in FIG. 6 may be performed in parallel.

FIG. 7 is a view illustrating a method for calibrating a display panel according to an embodiment of the present disclosure.

Referring to FIG. 7, a display panel 711 of a display device 710 is controlled to output a content image or a reference image 721. Although the reference image 721 is an image to be output, the color, brightness, saturation, and the like may be changed and output according to the setting or operation state of the display panel 711.

A camera 701 of the AI apparatus 100 may receive a captured image 722 by photographing the display panel 711 of the display device 710. The captured image 722 includes the display panel 711. The captured image 722 may be captured differently according to the setting or operation state of the display panel 711 and context information 723.

The processor 180 of the AI apparatus 100 may determine an image preprocessing parameter set 731 based on the reference image 721, the captured image 722, and the context information 723. As described above, the processor 180 of the AI apparatus 100 may determine the image preprocessing parameter set 731 in consideration of a user's preprocessing record.

The processor 180 of the AI apparatus 100 generates a preprocessed reference image 741 by preprocessing the reference image 721 using the image preprocessing parameter set 731. The processor 180 of the AI apparatus 100 may compare the preprocessed reference image 741 with the captured image 722 to generate a comparison result 751, and calibrate the display panel 711 of the display device 710 by using the comparison result 751.

FIG. 8 is a view illustrating a method for determining an image preprocessing parameter set according to an embodiment of the present disclosure.

Referring to FIG. 8, the processor 180 of the AI apparatus 100 may determines a image preprocessing parameter set 831 from a reference image 811, a captured image 812, and context information 813 using an image preprocessing parameter determination model 820.

The image preprocessing parameter determination model 820 may be learned by using training data generated from the user's image preprocessing record. The image preprocessing record may include a reference image, a captured image, context information, and image preprocessing parameters corresponding thereto. Therefore, training data including the reference image, the captured image, the context information, and the image preprocessing parameters corresponding thereto as label information may be generated from the image preprocessing record, and the generated training data may be used to train the image preprocessing parameter determination model 820. The image preprocessing parameter determination model 820 is learned to follow the user's image preprocessing record. Therefore, in the same situation (reference image, captured image, and context information) as a particular image preprocessing record, the image preprocessing parameter determination model 820 may determine an image preprocessing parameter set that is identical to or similar to the image preprocessing parameters included in the corresponding particular image preprocessing record.

In the reference image 811 and the captured image 812, original image data representing color information about each pixel may be input to the image preprocessing parameter determination model 820, and an image feature or an image feature vector extracted from each image may be input to the image preprocessing parameter determination model 820. For example, the image feature or the image feature vector extracted from each image may include an average, variance, distribution, and the like for each of color, brightness, and saturation of the image.

The image preprocessing parameter determination model 820 may be learned by the processor 180 or the learning processor 130 of the AI apparatus 100 and stored in the memory 170 of the AI apparatus 100, and may be learned by the processor 260 or the learning processor 240 of the AI server 200 and stored in the memory 230 of the AI server 200 or the memory 170 of the AI apparatus 100.

If the image preprocessing parameter determination model 820 is stored only in the memory 230 of the AI server 200, the processor 180 of the AI apparatus 100 may transmit the reference image 811, the captured image 812, and the context information 813 to the AI server 200 via the communication unit 110, the processor 260 of the AI server 200 may determine the image preprocessing parameter set by using the image preprocessing parameter determination model 820 stored in the memory 230, and the processor 180 of the AI apparatus 100 may receive the determined image preprocessing parameter set from the AI server 200 via the communication unit 110.

FIG. 9 is a view illustrating an example of training data for an image preprocessing parameter determination model according to an embodiment of the present disclosure.

Referring to FIG. 9, training data 910 for an image preprocessing parameter determination model may include a reference image 911, a captured image 912, context information 913, and image preprocessing parameters 914 corresponding thereto as label information. As described above, the training data 910 for the image preprocessing parameter determination model may be generated from a user's image preprocessing record.

The context information 913 may include weather, temperature, humidity, and air quality (e.g., pm2.5, pm10, etc.), and the image preprocessing parameter 914 may include calibration values of color, saturation, and brightness.

FIG. 10 is a flowchart illustrating an example of step S611 of calibrating a display panel illustrated in FIG. 6.

Referring to FIG. 10, the processor 180 of the AI apparatus 100 calculates an offset for a display panel for each predetermined unit by using a preprocessed reference image and a captured image (S1001).

The offset may refer to a difference of color, brightness, and saturation between the captured image and the preprocessed reference image, and may be calculated for each predetermined unit. The offset may include a position for each predetermined position and a difference of color, brightness, and saturation at the corresponding position. For example, the processor 180 may determine an offset corresponding to each unit pixel of the display panel. Alternatively, the processor 180 may determine an offset corresponding to each unit display panel of the display panel group.

The processor 180 may express the color of the captured image and the color of the preprocessed reference image by using an HSV model, an RGB model, or a YCbCr model, and may calculate an offset based on the expressed color model.

The processor 180 may map the preprocessed reference image and the captured image, and determine an offset by using mapping information. The mapping information may include coordinate relationship information between the preprocessed reference image and the captured image.

The processor 180 of the AI apparatus 100 determines a calibration value for the display panel by using the calculated offset (S1003).

The calibration value refers to a correction value or an adjustment value that is additionally calculated with respect to an output setting value when the display panel outputs an image, and the processor 180 may determine the calibration value for each predetermined unit. For example, the processor 180 may determine a calibration value corresponding to each unit pixel of the display panel. Alternatively, the processor 180 may determine a calibration value corresponding to each unit display panel of the display panel group.

The calibration value may be composed of values to be calibrated for the output setting values including color, brightness, and saturation, and may be composed of values to be calibrated for the output setting values including brightness, gamma, contrast, and balance. The calibration value may be composed of a value added to the output setting value in the display panel, may be composed of a value multiplied, or may include a value added and a value multiplied.

In one embodiment, the processor 180 may calculate calibration values based on zero. This may refer to a situation in which the display panel is calibrated to output the preprocessed reference image as accurately as possible. For example, the display panel is divided into four units. If the offset of (color, brightness, saturation) for each unit is {(0, 1, 0), (1, 1, 2), (0, 0, 0), (2, 1, 4)}, the processor 180 may determine the calibration value of (color, brightness, saturation) for each unit as {(0, −1, 0), (−1, −1, −2), (0, 0, 0), (−2, −1, −4)} by subtracting each offset value with respect to zero.

The processor 180 of the AI apparatus 100 transmits the determined calibration value to the display panel (S1005).

The calibration value may refer to a calibration value of the output setting value of the display panel. The processor 180 may calibrate the output setting value of the display panel by transmitting the calibration value to the display panel, thereby removing color distortion. Alternatively, the processor 180 may transmit the calibration value to the controller that controls the display panel.

If the calibration value for removing distortion in the display panel already exists, the display panel or the controller of the display panel may additionally reflect the received calibration value to the existing calibration value.

Alternatively, if there is a history that previously determines the calibration value, the processor 180 may determine a new calibration value by reflecting the previous calibration value and the currently determined calibration value together, and may transmit the newly determined calibration value to the display panel. In this situation, the display panel may perform calibration to remove color distortion by simply applying the calibration value transmitted from the processor 180 without considering the previous calibration values.

The order of the steps illustrated in FIG. 10 is merely an example, and the present disclosure is not limited thereto. That is, in one embodiment, the order of some of steps illustrated in FIG. 10 may be mixed. In addition, in one embodiment, some of steps illustrated in FIG. 10 may be performed in parallel.

FIG. 11 is a view illustrating a method for removing color distortion of a display panel according to an embodiment of the present disclosure.

Referring to FIG. 11, the display device 1120 may include one display panel group including a plurality of display panels 1121, 1122, 1123, and 1124. In FIG. 11, the display device 1120 is illustrated as a digital signage, but the present disclosure is not limited thereto. In addition, although the display device 1120 is illustrated in FIG. 11 so that a plurality of display panels constitute one display panel group, the present disclosure is not limited thereto.

The processor 180 of the AI apparatus 100 may capture an image of the display device 1120 via the camera 1110 and receive the captured image.

The AI apparatus 100 may transmit a control signal to output the preprocessed reference image 1140 to the display device 1120, and output the preprocessed reference image 1140. The preprocessed reference image may be an image having an average hue of 20 (or an average of hue is 20), an average value of 30, and an average saturation of 50 in all regions 1141, 1142, 1143, and 1144. The regions may refer to image regions corresponding to the unit display panels 1121, 1122, 1123, and 1124.

However, the captured image 1130 obtained by the camera 1110 of the AI apparatus 100 may be different from the reference image 1140. In detail, in the first region 1131, the second region 1132, and the third region 1133, among the four regions 1131, 1132, 1133, and 1134, the same average color values (H: 20, V: 30, S: 50) as the first to third regions 1141, 1142 and 1143 of the preprocessed reference image 1140 may be measured. In the fourth region 1134, the average color values (H: 30, V: 30, and S: 50) different from the fourth region 1144 of the preprocessed reference image 1140 may be measured.

Since the processor 180 of the AI apparatus 100 may grasp that the average hue value in the fourth region 1134 of the captured image 1130 has 30 which is 10 greater than the average hue value in the fourth region 1144 of the preprocessed reference image 1140, the processor 180 of the AI apparatus 100 may calculate the offset based on the comparison result. The processor 180 of the AI apparatus 100 may express the offset value by an ordered pair of a difference of an average H (hue), an average V (value), and an average S (saturation) between the captured image 1130 and the preprocessed reference image 1140.

The processor 180 of the AI apparatus 100 may calculate the offset corresponding to the regions 1131, 1132, 1133, and 1134 of the captured image 1130 as the offset. For example, the processor 180 of the AI apparatus 100 may calculate {(0, 0, 0), (0, 0, 0), (0, 0, 0), (10, 0, 0)} as the offset.

The processor 180 of the AI apparatus 100 may determine the calibration value 1150 in consideration of the calculated offset. The calibration value 1150 is a calibration value for correcting the colors of the display panels 1121, 1122, 1123, and 1124 of the display device 1120. In the example of FIG. 11, the calibration value 1150 may be expressed as (dH, dV, dS) which are the calibration values of (H, V, S) of the display panels 1121, 1122, 1123, and 1124. For example, the processor 180 of the AI apparatus 100 may determine {(0, 0, 0), (0, 0, 0), (0, 0, 0), (−10, 0, 0)} as the calibration value 1150 in consideration of the calculated offset of {(0, 0, 0), (0, 0, 0), (0, 0, 0), (10, 0, 0)}.

The processor 180 of the AI apparatus 100 may transmit the determined calibration value 1150 to the display device 1120 to calibrate or correct (H, V, S) by the calibration value 1150 when outputting the image from the display panels 1121, 1122, 1123, and 1124.

In the example of FIG. 11, the display device 1120 adds the calibration value 1150 to the output value (H, V, S), but the present disclosure is not limited thereto. That is, in another embodiment, the value to be multiplied as well as the value added to (H, V, S) may be added to the calibration value 1150, or the calibration value may be configured only with the value to be multiplied. For example, in the example of the captured image 1130 and the preprocessed reference image 1140 in FIG. 11, the processor 180 of the AI apparatus 100 may determine {(1, 1, 1), (1, 1, 1), (1, 1, 1), (⅔, 1, 1)} as the calibration value, and this may mean multiplying the output value (H, V, S) by the calibration value.

FIG. 12 is a view illustrating a method for determining a region where color distortion occurs according to an embodiment of the present disclosure.

Referring to FIG. 12, in a captured image 1210 obtained by photographing the display device 300 by using the camera 121 of the AI apparatus 100, a plurality of display panels constitute a single display panel group. Accordingly, the captured image 1210 may be constituted by a plurality of regions. 1211, 1212, 1213, and 1214.

The processor 180 of the AI apparatus 100 observes the boundary regions 1221, 1222, 1223, and 1224 of each region in the captured image 1210, and may compare the fourth region 1214 with the first to third regions 1211, 1212, and 1213 to determine the occurrence of color distortion based on the boundary regions 1223 and 1224 where a color difference occurs.

FIGS. 11 and 12 illustrate an example of a display device 1120 in which a plurality of display panels constitute a single display panel group, the processor 180 of the AI apparatus 100 may receive and use information about the configuration and layout of the display panels from the display device 1120.

In addition, FIGS. 11 and 12 illustrate an example of a display device 1120 in which a plurality of display panels constitute a single display panel group, but the present disclosure is not limited thereto as described above. A display device including a single display panel may also be calibrated to remove color distortion for a predetermined unit such as a pixel unit.

According to various embodiments of the present disclosure, the user may observe the image output from the display panel without color distortion.

In addition, according to various embodiments of the present disclosure, since the display panel is calibrated to a user's preferred state in consideration of the environment and the image output by the display panel, the user may observe the image having the color corresponding to the preference for each situation.

According to an embodiment of the present disclosure, the above-described method can be implemented as a processor-readable code in a non-transitory computer readable medium where a program is recorded, such as a hard disk drive (HDD), a solid state drive (SSD), a silicon disk drive (SDD), read-only memory (ROM), random access memory (RAM), CD-ROM, a magnetic tape, a floppy disk, and an optical data storage device.

Other implementations are within the scope of the following claims.

What is claimed is:

1. An artificial intelligence apparatus for calibrating a display panel, the artificial intelligence apparatus comprising:
a camera; and
a processor configured to:
receive a captured image of the display panel captured via the camera,
receive a reference image corresponding to the captured image,
receive context information at a reception time of the captured image,
determine an image preprocessing parameter set based on the captured image, the reference image and the context information,
preprocess the reference image based on the image preprocessing parameter to generate a preprocessed reference image, and
calibrate the display panel based on the preprocessed reference image and the captured image.

2. The artificial intelligence apparatus according to claim 1, wherein the processor is further configured to:
remove a region not including a display panel region from the captured image, and
convert the display panel region in the captured image into a rectangular shape.

3. The artificial intelligence apparatus according to claim 2, wherein the context information includes time information and weather information,
wherein the time information includes at least one of a date or a time, and
wherein the weather information includes at least one of a weather condition, temperature, humidity, or air quality.

4. The artificial intelligence apparatus according to claim 3, wherein the image preprocessing parameter includes at least one of a brightness calibration parameter, a saturation calibration parameter, a color calibration parameter, or a noise cancellation parameter.

5. The artificial intelligence apparatus according to claim 4, wherein the processor is further configured to:
determine the image preprocessing parameter based on an image preprocessing record, and
wherein the image preprocessing record includes an image filter application record of previously applied image filters.

6. The artificial intelligence apparatus according to claim 5, wherein the processor is further configured to:
determine the image preprocessing parameter from the captured image, the preprocessed reference image, and the context information based on an image preprocessing parameter determination model, and
wherein the preprocessing parameter determination model includes an artificial neural network and is learned according to a machine learning algorithm or a deep learning algorithm.

7. The artificial intelligence apparatus according to claim 5, wherein the image preprocessing parameter determination model is trained with training data generated from the image preprocessing record.

8. The artificial intelligence apparatus according to claim 1, wherein the processor is further configured to:
compare the preprocessed reference image with the captured image,
calculate an offset for the display panel for each predetermined unit constituting the display panel,
determine a calibration value for the display panel based on the offset, and
calibrate the display panel based on the calibration value.

9. The artificial intelligence apparatus according to claim 8, wherein the offset is a difference in color, brightness, or saturation between the preprocessed reference image and the captured image.

10. The artificial intelligence apparatus according to claim 8, wherein the calibration value includes at least one of brightness, gamma, contrast, or balance for the display panel.

11. The artificial intelligence apparatus according to claim 8, wherein the display panel is constituted by a single unit display panel or a plurality of unit display panels connected together.

12. The artificial intelligence apparatus according to claim 11, wherein the predetermined unit is a unit display element included in the single unit display panel or the plurality of unit display panels.

13. The artificial intelligence apparatus according to claim 8, wherein the display panel is a flexible display panel, and wherein the predetermined unit is a unit display element of the flexible display panel.

14. A method for calibrating a color of a display panel, the method comprising:
receiving a captured image of the display panel captured via a camera;
receiving a reference image corresponding to the captured image;
receiving context information at a reception time of the captured image;
determining an image preprocessing parameter set based on the captured image, the reference image and the context information;
preprocessing the reference image based on the image preprocessing parameter; and
calibrating the display panel based on the preprocessed reference image and the captured image.

15. The method according to claim 14, further comprising:
removing a region not including a display panel region from the captured image; and
converting the display panel region in the captured image into a rectangular shape.

16. The method according to claim 14, further comprising:
determining the image preprocessing parameter based on an image preprocessing record, wherein the image preprocessing record includes an image filter application record of previously applied image filters.

17. The method according to claim 16, further comprising:
determining the image preprocessing parameter from the captured image, the preprocessed reference image, and the context information based on an image preprocessing parameter determination model,
wherein the preprocessing parameter determination model includes an artificial neural network and is learned according to a machine learning algorithm or a deep learning algorithm.

18. The method according to claim 14, further comprising:
comparing the preprocessed reference image with the captured image;
calculating an offset for the display panel;
determining a calibration value for the display panel based on the offset; and
calibrating the display panel based on the calibration value.

19. The method according to claim 18, wherein the offset is a difference in color, brightness, or saturation between the preprocessed reference image and the captured image, or
wherein the calibration value includes at least one of brightness, gamma, contrast, or balance for the display panel.

20. A non-transitory computer readable recording medium having recorded thereon a computer program for controlling a processor to perform a method for calibrating a display panel, the method comprising:
receiving a captured image for the display panel captured via a camera;
receiving a reference image corresponding to the captured image;
receiving context information at a reception time of the captured image;
determining an image preprocessing parameter set based on the captured image, the reference image and the context information;
preprocessing the reference image based on the image preprocessing parameter set; and
calibrating the display panel based on the preprocessed reference image and the captured image.
